(19) United States
(12) Patent Application Publication
(10) Pub. No.: US 2026/0350647 A1
(43) Pub. Date: Nov. 5, 2026

(54) OPTIMIZATION DEVICE AND INFERENCER GENERATION DEVICE

(71) Applicant: NTT DOCOMO, INC., Tokyo (JP)

(72) Inventors: Akinari SAKAI, Tokyo (JP); Keiichi OCHIAI, Tokyo (JP); Gentarou KATAYAMA, Tokyo (JP); Takashi SUZUKI, Tokyo (JP); Akira YAMADA, Tokyo (JP)

(73) Assignee: NTT DOCOMO, INC., Tokyo (JP)

(21) Appl. No.: 19/148,118

(22) PCT Filed: Feb. 6, 2024
(86) PCT No.: PCT/JP2024/003955

§ 371 Date: Jul. 15, 2025

(30) Foreign Application Priority Data
Apr. 13, 2023 (JP) 2023-065391

(51) Int. Cl. G06Q 30/0208; G06N 5/04; G06Q 10/04

(52) U.S. Cl. CPC G06Q 30/0208; G06N 5/04; G06Q 10/04

(57) ABSTRACT

An optimization device 20 is a device for presenting an incentive to a user U to change a behavior of the user U. The optimization device 20 includes an inference unit 22 configured to infer, for each intervention pattern, a response score indicating a degree of response of a user U based on attribute information of the user U to be inferred, each intervention pattern being a combination of a non-monetary factor that is a means for encouraging the user U to perform a specific behavior and an incentive amount that is a monetary reward for the specific behavior, and an optimization unit 23 configured to determine the intervention pattern based on the response score.

### TECHNICAL FIELD

The present invention relates to an optimization device and an inferencer generation device.

### BACKGROUND ART

In the related art, it has been common to present an incentive to a user to change a behavior of the user. For example, Patent Literature 1 describes changing a user's behavior by presenting the user with incentives including non-monetary factors and monetary rewards.

### CITATION LIST

### Patent Literature

[Patent Literature 1] Japanese Unexamined Patent Publication No. 2014-099173

### SUMMARY OF INVENTION

### Technical Problem

In the device described in Patent Literature 1, in a case where a non-monetary factor is combined with an incentive amount and presented to a user, simply combining them does not improve the probability that a user U will undergo behavioral change. This is because when a combination of non-monetary factors and incentive amounts is presented to a plurality of users, each user's psychological tendency is different from the other users'. Therefore, in order to improve the behavioral change rate of the user, it is important to optimize the incentive amount while considering the influence of non-monetary factor.

In order to solve the above problem, one embodiment of the present invention aims to provide an optimization device that can determine an optimal combination of an incentive amount and a non-monetary factor, and an inferencer generation device used therein.

### Solution to Problem

An optimization device according to an embodiment of the present invention is a device for presenting an incentive to a user to change a behavior of the user. The optimization device includes an inference unit configured to infer, for each intervention pattern, a response score indicating a degree of response of a user based on attribute information of the user to be inferred, each intervention pattern being a combination of a non-monetary factor that is a means for encouraging the user to perform a specific behavior and an incentive amount that is a monetary reward for the specific behavior, and an optimization unit configured to determine the intervention pattern based on the response score.

### Advantageous Effects of Invention

According to one embodiment of the present invention, an optimal combination of an incentive amount and a non-monetary factor can be determined.

### BRIEF DESCRIPTION OF DRAWINGS

FIG. 1 is a diagram illustrating an information processing system 100 according to the present disclosure.

FIG. 2 is a block diagram illustrating a functional configuration of an inferencer generation device 10 and an optimization device 20 according to the present disclosure.

FIG. 3 is a diagram illustrating an example of candidate incentive amounts.

FIG. 4 is a diagram illustrating a candidate incentive amount and behavioral result of a user U with respect to the candidate incentive amount.

FIG. 5 is a diagram illustrating an example of initial scores for candidate incentive amounts.

FIG. 6 is a diagram illustrating a selected intervention pattern set by an initial data acquisition unit 12.

FIG. 7 is a diagram illustrating behavioral results for each user U with respect to selected intervention patterns.

FIG. 8 is a diagram illustrating an example of attribute information of a user U.

FIG. 9 is a diagram illustrating an example of learning information.

FIG. 10 is a diagram illustrating an example of attribute information and behavioral results corresponding to a specific selected intervention pattern.

FIG. 11 is a diagram illustrating an example of a response rate of each user U for each selected intervention pattern.

FIG. 12 is a flowchart illustrating a procedure of a process of determining an intervention pattern by an optimization unit 23.

FIG. 13 is a diagram for describing a process of determining an intervention pattern by the optimization unit 23.

FIG. 14 is a flowchart illustrating a procedure of a process of changing the intervention pattern by the optimization unit 23.

FIG. 15 is a diagram for describing a process of determining an intervention pattern by the optimization unit 23.

FIG. 16 is a diagram for describing a process of determining an intervention pattern by the optimization unit 23.

FIG. 17 is a sequence diagram illustrating a processing procedure of information processing for generating an inferencer 40 in the inferencer generation device 10.

FIG. 18 is a sequence diagram illustrating processing procedures of information processing for determining an intervention pattern in the optimization device 20 and information processing for providing an incentive by an incentive providing device 30.

FIG. 19 is a sequence diagram illustrating a processing procedure of information processing for regenerating the inferencer 40 in the inferencer generation device 10.

FIG. 20 is a diagram illustrating an example of a hardware configuration of the inferencer generation device 10, the optimization device 20, and the incentive providing device 30 according to an embodiment of the present disclosure.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

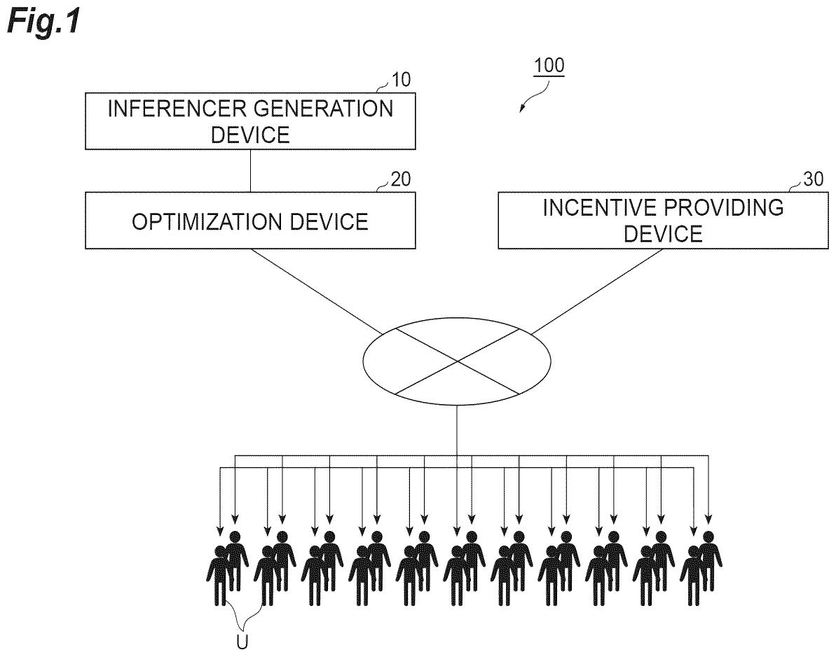

FIG. 1 is a diagram illustrating an overview of an information processing system 100 according to the present disclosure. The information processing system 100 is a system for encouraging a user U to perform a specific behavior by presenting an incentive to the user U via a network. The information processing system 100 grants a predetermined incentive to the user U in a case where the user U performs a specific behavior. For example, in a case where the user U takes a specific behavior such as purchasing a specific product, or in a case where the user U uses a specific service, the information processing system 100 determines that the user U has taken the specific behavior and grants an incentive to the user U. The specific behavior may be any behavior other than those mentioned above.

Incentives are interventions used to encourage specific behaviors across various services. Incentives include intervention patterns that are a combination of incentive amounts and non-monetary factors. An incentive amount is a monetary reward for a specific behavior. For example, the incentive amount may be money itself, points in a service provided to user U, a discount amount when user U presents a coupon, or any other monetary reward other than those mentioned above. A non-monetary factor is a non-monetary means for encouraging the user U to take a specific behavior, other than presenting the above-mentioned incentive amount. For example, a non-monetary factor may be gamification or nudge given to the service, or other means other than those mentioned above to encourage users to take specific behaviors without providing monetary rewards.

As an example, the information processing system 100 is a system that distributes advertisements to each user U to promote sustainable products. This advertisement is displayed, for example, on a screen to which a transition can be made from a push notification displayed on the user U's terminal. A sustainable product is one that can reduce the burden on the environment as a result of purchasing or using the product. In the advertisement, the information processing system 100 presents, as an incentive amount, the amount of points that will be awarded to the user U when the user U purchases the sustainable product, along with a message for promoting the sustainable product. At the same time, the information processing system 100 may present to the user U, as a non-monetary factor, information in the advertisement that “a portion of the sales will be donated.” This makes it possible to present to the user U that by purchasing sustainable products, he or she can contribute to environmental conservation. As a result, it becomes possible to encourage the purchase of sustainable products. In addition, the information processing system 100 may present the user U with information indicating a ranking of purchase numbers of sustainable products as a non-monetary factor at the same time as presenting the incentive amount. This makes it possible to stimulate the sense of competition of the user U against other users U and encourage the user U to take a specific behavior.

The information processing system 100 includes an inferencer generation device 10, an optimization device 20, and an incentive providing device 30. The inferencer generation device 10 generates an inferencer for inferring the response score of the user U for each intervention pattern. The optimization device 20 determines an intervention pattern for each user U based on the response score inferred using the inferencer. The incentive providing device 30 presents the intervention pattern determined by the optimization device 20 to the user U. For example, the optimization device 20 determines how much of an incentive amount to include in the intervention pattern based on the response score of the user U. The optimization device 20 determines, based on the response score of the user U, whether or not to include a non-monetary factor in the intervention pattern, or what type of non-monetary factor to include in the intervention pattern. The response score is an index representing the degree of response of the user U with respect to the intervention pattern, for example, an index representing the ease with which the user U responds to the intervention pattern. As an example, the response score is a response rate, which is the probability that the behavior of the user U will change.

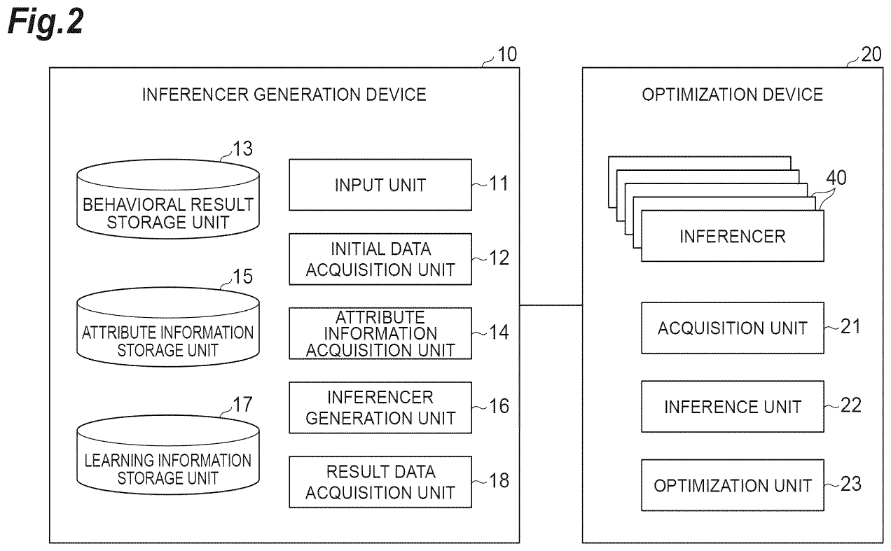

FIG. 2 is a block diagram illustrating a functional configuration of the inferencer generation device 10 and the optimization device 20. The inferencer generation device 10 includes an input unit 11, an initial data acquisition unit 12, a behavioral result storage unit 13, an attribute information acquisition unit 14, an attribute information storage unit 15, an inferencer generation unit 16, a learning information storage unit 17, and a result data acquisition unit 18. Each functional unit will be described in detail below.

The input unit 11 receives an input of attribute information and initial data of the user U. The input unit 11 outputs the attribute information of the user U to the attribute information acquisition unit 14. The input unit 11 outputs the initial data to the initial data acquisition unit 12. The initial data is information including a plurality of candidate incentive amounts and the initial score of the user U when each candidate incentive amount is presented to the user U. The initial score of the user U is a response score of the user U for each candidate incentive amount. The initial data is set in advance by an administrator of the information processing system 100 or the like.

Hereinafter, a method for generating the initial data will be described. First, a business operator who presents incentives to user U (hereinafter referred to as a “business operator”) sets a reference incentive amount N, which is the amount of incentive per person that the business operator can allow. The reference incentive amount N is the upper limit of the incentive amount that the business operator can grant to each user U. The sum of amounts of incentives presented to all users U is equal to or less than a numerical value obtained by multiplying the reference incentive amount N by the number of users U. The reference incentive amount N is, for example, 200. As an example, for the promotion of a product that costs 2,000 yen, points equivalent to 200 yen, which is 10% of the price of the product, are set as the reference incentive amount N. In addition, an incentive amount exceeding the reference incentive amount N may be granted (distributed) to one user U.

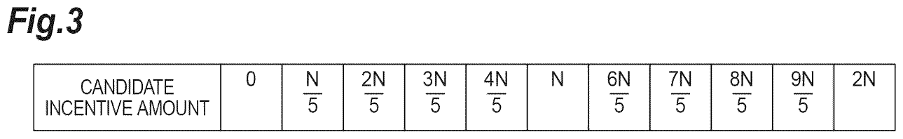

Next, the business operator or the like determines the candidate incentive amount to be presented to the user U and its range (distribution range) based on the reference incentive amount N using a predetermined logic. Each of the plurality of candidate incentive amounts is determined at predetermined intervals based on the reference incentive amount. FIG. 3 is a diagram illustrating an example of a plurality of candidate incentive amounts. In the example illustrated in FIG. 3, one candidate incentive amount is a reference incentive amount N, and other candidate incentive amounts are determined at predetermined intervals centered on this reference incentive amount N. The predetermined intervals are preferably equal intervals, but are not limited thereto. The candidate incentive amounts are set from 0 to 2N in increments of N/5. As an example, when N=200, the candidate incentive amounts are set from 0 to 400 in increments of 40. The candidate incentive amounts may be determined by a predetermined method as described above, or may be set randomly.

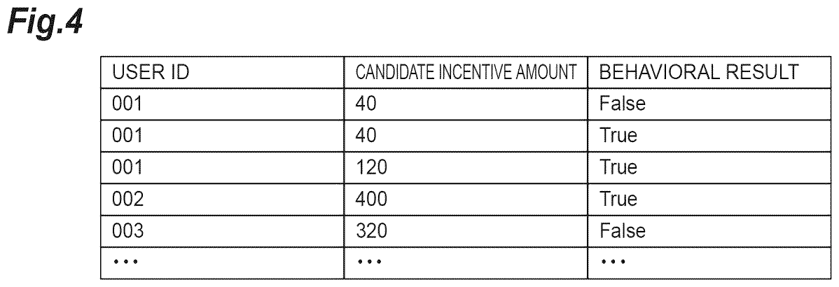

Next, a business operator or the like presents candidate incentive amounts to the user U as rewards for a specific behavior, and acquires information indicating whether or not the behavior of the user U has changed. As an example, the set candidate incentive amounts are each varied and distributed to each of a plurality of users U on a trial basis for one week, and the behavioral results of each user U for each of the plurality of distributed candidate incentive amounts are acquired. FIG. 4 is a diagram illustrating the behavioral results of user U with respect to candidate incentive amounts. In the example illustrated in FIG. 4, the candidate incentive amounts and behavioral results are shown for each user U. The behavioral result is information indicating whether or not the behavior of the user U has been changed (True or False), and as an example, is information indicating whether or not the user U has performed a specific behavior. For example, in the table illustrated in FIG. 4, in a case where a user U corresponding to user ID: 001 is presented with a 40 yen discount coupon that will be given if he or she purchases a specific product, the behavioral result of when the user U purchases the specific product (True) and the behavioral result of when the user U does not purchase the specific product (False) are shown.

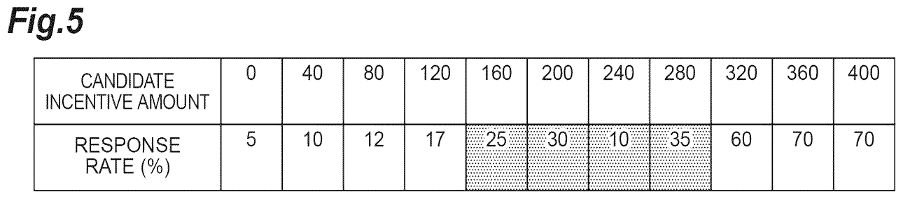

In a case where the candidate incentive amounts are presented to the user U by a business operator or the like, a response score, which is the probability that the behavior of the user U will change, is calculated as an initial score for each candidate incentive amount. Specifically, the business operator or the like measures the response rate for each candidate incentive amount based on information indicating whether or not the behavior of the user U has changed. FIG. 5 is a diagram illustrating the response rate of the user U for each candidate incentive amount. In the example illustrated in FIG. 5, the probability that the behavior of the user U will change with respect to the candidate incentive amount is calculated as an initial score for each candidate incentive amount based on the table illustrated in FIG. 4. For example, in a case where a plurality of users U are presented with a 40 yen discount coupon that will be given if they purchase a specific product, it is calculated that there is a 10% probability that the specific product will be purchased.

The initial data acquisition unit 12 acquires an initial score for each candidate incentive amount as initial data. The initial data acquisition unit 12 determines the incentive amount to be combined with the non-monetary factor based on a predetermined logic. Specifically, the initial data acquisition unit 12 selects a selected incentive amount from a plurality of candidate incentive amounts based on the initial score for each candidate incentive amount.

For example, the initial data acquisition unit 12 selects a selected incentive amount from a plurality of candidate incentive amounts based on the calculated statistical values of the initial scores, as in the following first to fourth examples. In the first example, the statistical value is the overall response rate. In this example, the initial data acquisition unit 12 selects, as the selected incentive amount, a candidate incentive amount whose response rate, which is the initial score, is within ±15% of the overall response rate. The initial data acquisition unit 12 may select, as the selected incentive amount, a plurality of candidate incentive amounts that are equal to or greater than the minimum value and equal to or less than the maximum value of the selected incentive amount. In the example illustrated in FIG. 5, when the overall response rate is 33%, the initial data acquisition unit 12 selects candidate incentive amounts of 160 and 280 as the minimum value and the maximum value of the candidate incentive amounts that are ±15% relative to the response rate. The initial data acquisition unit 12 selects (determines) a plurality of candidate incentive amounts 160,200, 240, and 280, which are equal to or greater than the minimum value 160 and equal to or less than the maximum value 280 of the selected incentive amount, as selected incentive amounts (appropriate incentive amounts) (see the shaded portions in FIG. 5).

In the second example, the statistical values are the first quartile and the third quartile. In this example, the initial data acquisition unit 12 may select, as the selected incentive amount, a candidate incentive amount that is equal to or greater than the first quartile and equal to or less than the third quartile of the response rate for each candidate incentive. In the example illustrated in FIG. 5, the initial data acquisition unit 12 selects, as the selected incentive amount, a candidate incentive amount that is greater than or equal to 80 (first quartile) and less than or equal to 320 (third quartile).

In the third example, the statistical value is the median value. In this example, the initial data acquisition unit 12 may select a candidate incentive amount as the selected incentive amount in a case where the response rate corresponding to the candidate incentive amount is within ±15% of the response rate (median value) corresponding to the reference incentive amount N. In the example illustrated in FIG. 5, the initial data acquisition unit 12 selects, as the selected incentive amounts, a plurality of candidate incentive amounts 120, 160, 200, 240, and 280 that have a response rate of 15% or more and 45% or less.

In the fourth example, the statistical value is the difference in response rate between two adjacent candidate incentive amounts. In this example, when all the candidate incentive amounts are arranged in ascending or descending order, in a case where the differences between each two adjacent candidate incentive amounts among four consecutive candidate incentive amounts are all 5 or less, the initial data acquisition unit 12 may select the four candidate incentive amounts as the selected incentive amounts. For example, in a case where the response rates are 30, 34, 40, 40, 41, and 41 in ascending order of the candidate incentive amounts, the incentive amounts corresponding to 40, 40, 41, and 41 may be selected as the selected incentive amounts. The above first to fourth examples are merely examples, and the present invention is not limited to the above.

The initial data acquisition unit 12 sets a combination of the selected incentive amount and the non-monetary factor as a selected intervention pattern. The initial data acquisition unit 12 presents the set selected intervention pattern to the user U and acquires the behavioral results of the user U with respect to the selected intervention pattern. The initial data acquisition unit 12 outputs the selected intervention pattern and the behavioral result to the behavioral result storage unit 13. The behavioral result storage unit 13 stores the selected intervention pattern and the behavioral result acquired from the initial data acquisition unit 12 or the result data acquisition unit 18 to be described below. The initial data acquisition unit 12 may randomly present each selected intervention pattern to the user U, or may divide the users U into groups in advance and present the same selected intervention pattern to a plurality of users U included in the same group.

For example, the initial data acquisition unit 12 sets a selected intervention pattern in which each selected incentive amount is associated with one of a plurality of non-monetary factors. The initial data acquisition unit 12 sets a selected intervention pattern in which the incentive amount is set to 0 and is associated with any one of a plurality of non-monetary factors. The initial data acquisition unit 12 sets a selected intervention pattern in which each selected incentive amount is not associated with a non-monetary factor. The initial data acquisition unit 12 acquires a selected intervention pattern and a behavioral result for each user with respect to the selected intervention pattern. Therefore, the initial data acquisition unit 12 acquires selected intervention patterns that combine non-monetary factors with an incentive range to which the user U is likely to respond, and data showing the behavioral results with respect to each selected intervention pattern. The plurality of selected intervention patterns also include intervention patterns that do not include an incentive.

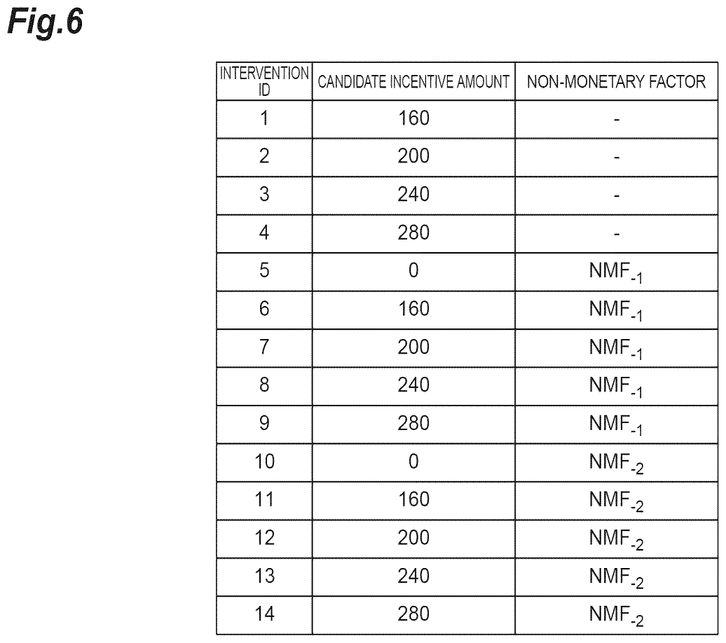

FIG. 6 is a diagram illustrating the selected intervention patterns set by the initial data acquisition unit 12. In the example illustrated in FIG. 6, the initial data acquisition unit 12 generates data combining non-monetary factors with the selected incentive amounts of 160, 200, 240, and 280. For example, the initial data acquisition unit 12 sets intervention patterns in which the selected incentive amounts of 160, 200, 240, and 280 are not associated with non-monetary factors as intervention IDs: 1 to 4. The initial data acquisition unit 12 sets intervention patterns in which the selected incentive amounts of 160, 200, 240, and 280 are associated with a non-monetary factor NMF-1 (displaying the information that “a portion of the sales will be donated”) or a non-monetary factor NMF-2 (visualization of the ranking of purchase numbers of sustainable products) as intervention IDs: 6 to 9, and 11 to 14, respectively. The initial data acquisition unit 12 sets intervention patterns in which the incentive amount of 0 is associated with the non-monetary factor NMF-1 or the non-monetary factor NMF-2 as intervention IDs: 5 and 10, respectively. The initial data acquisition unit 12 distributes the set intervention IDs: 1 to 14 to a plurality of users U on a trial basis for one week, and acquires the behavioral results of the users U for each intervention ID: 1 to 14.

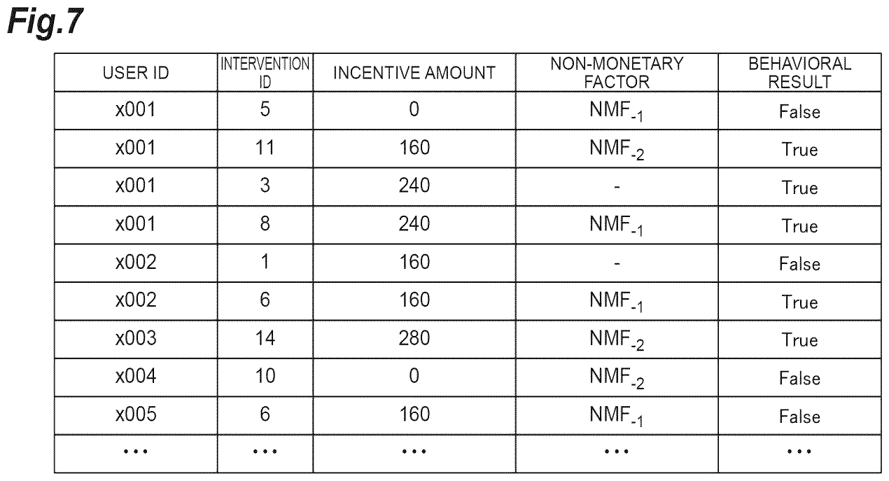

FIG. 7 is a diagram illustrating behavioral results for each user U with respect to selected intervention patterns. The table illustrated in FIG. 7 shows a user U corresponding to user ID: x001 and the behavioral results of the user U for intervention IDs: 3, 5, and 11. Also, for example, a user U corresponding to user ID: x002 and the behavioral results of the user U with respect to intervention IDs: 1 and 8 are shown. In the example illustrated in FIG. 7, the initial data acquisition unit 12 acquires the behavioral results of the user U for each intervention ID. The initial data acquisition unit 12 may measure the response rate of the user U to each intervention ID based on the acquired behavioral results.

As described above, the incentive amount to be combined with the non-monetary factor is specified in advance as the selected incentive amount. The initial data acquisition unit 12 sets a selected intervention pattern, which is a combination of a selected incentive amount and a non-monetary factor, and acquires the behavioral results of the user U with respect to the selected intervention pattern.

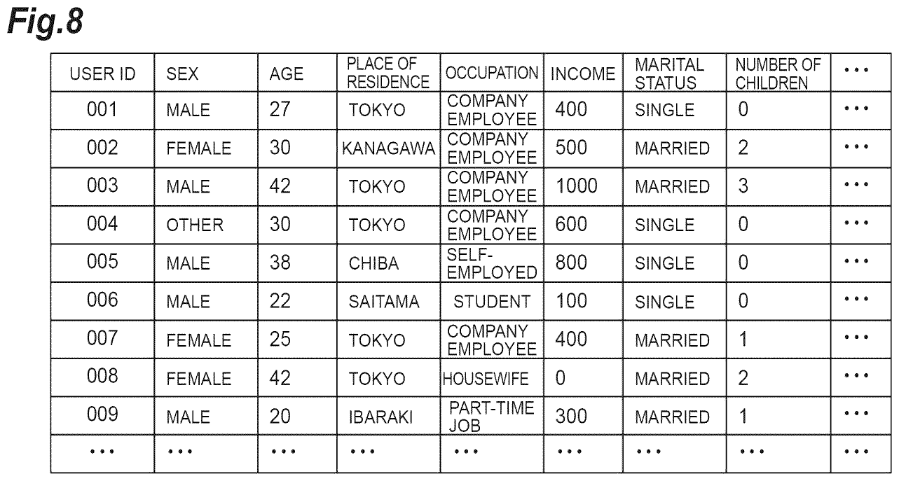

The attribute information acquisition unit 14 acquires attribute information of a plurality of users U from the input unit 11. The attribute information acquisition unit 14 outputs the attribute information of the plurality of users U to the attribute information storage unit 15. The attribute information storage unit 15 stores the attribute information of the plurality of users U acquired from the attribute information acquisition unit 14. The attribute information of the user U is information indicating at least the gender and age. The attribute information of the user U may be information indicating at least one of the place of residence, occupation, income, marital status, and number of children, in addition to gender and age. FIG. 8 is a diagram illustrating an example of attribute information of a plurality of users U. In the example illustrated in FIG. 8, the attribute information of user U is information indicating gender, age, place of residence, occupation, income, marital status, and number of children. In addition, the attribute information may be any property or characteristic that the user U possesses. Therefore, the attribute information is not limited to these, and may be one or several of them, or may include other information.

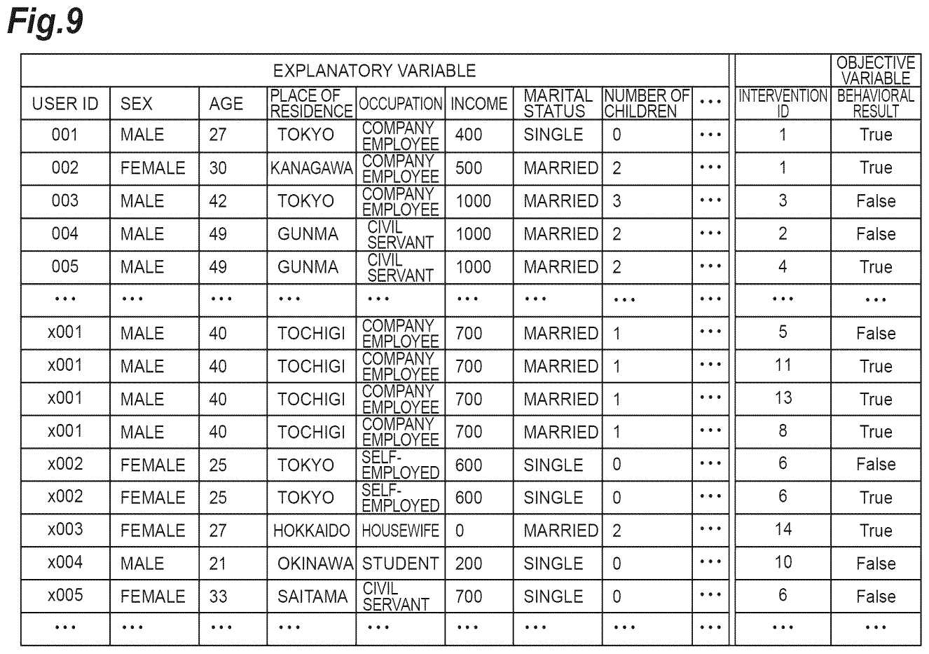

The inferencer generation unit 16 uses attribute information of a plurality of users U and behavioral results of the users U with respect to the selected intervention pattern to generate a plurality of inferencers 40 for each selected intervention pattern, for example, by machine learning. Specifically, first, the inferencer generation unit 16 acquires the selected intervention pattern and the behavioral result of the user U with respect to the selected intervention pattern from the behavioral result storage unit 13. The inferencer generation unit 16 acquires attribute information of a plurality of users U from the attribute information storage unit 15. The inferencer generation unit 16 generates learning information by associating the behavioral results with respect to the selected intervention pattern with attribute information of a plurality of users U based on information identifying the users U. The inferencer generation unit 16 outputs the generated learning information to the learning information storage unit 17. The learning information storage unit 17 stores the learning information acquired from the inferencer generation unit 16. FIG. 9 is a diagram illustrating an example of learning information. In the example illustrated in FIG. 9, the behavioral results of the user U with respect to the intervention ID are associated with attribute information of a plurality of users U based on the user ID.

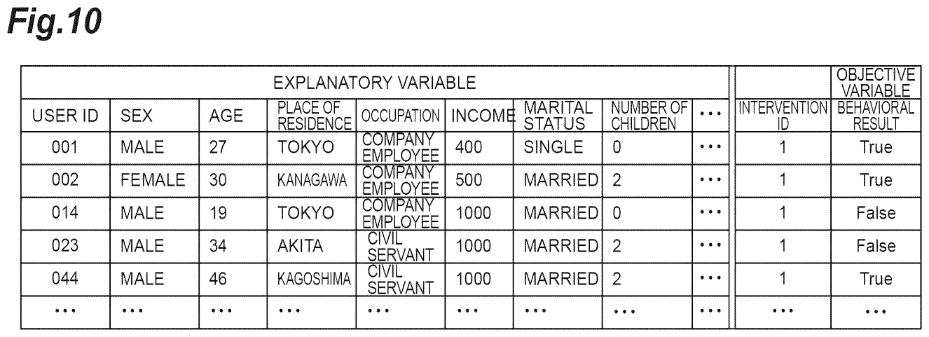

The inferencer generation unit 16 acquires learning information from the learning information storage unit 17. The inferencer generation unit 16 extracts attribute information and behavioral results corresponding to a specific selected intervention pattern from the acquired learning information. The inferencer generation unit 16 uses attribute information of the user U as explanatory variables and the behavioral results of the user U as objective variables to generate a plurality of inferencers 40 for each selected intervention pattern through machine learning. In the example illustrated in FIG. 10, the inferencer generation unit 16 extracts attribute information and behavioral results corresponding to intervention ID: 1. The inferencer generation unit 16 uses the extracted attribute information as explanatory variables and the extracted behavioral results as objective variables to generate an inferencer 40 corresponding to intervention ID: 1 through machine learning. The inferencer 40 may be constructed by a general machine learning method such as supervised learning, or may be constructed by a machine learning method other than the above.

In this manner, the inferencer generation unit 16 generates an inferencer 40 corresponding to each intervention pattern based on the data collected by the initial data acquisition unit 12 and the attribute information acquisition unit 14.

The result data acquisition unit 18 acquires result data including the intervention pattern presented to each user U by the incentive providing device 30, the behavioral results of the user U with respect to the intervention pattern, and attribute information of the user U. The intervention pattern presented to each user U by the incentive providing device 30 is, for example, the intervention pattern determined by the optimization device 20. The result data acquisition unit 18 outputs the acquired data to the behavioral result storage unit 13.

As described above, the inferencer generation device 10 multiplies the behavioral results of the user U for the selected intervention pattern with attribute information data, and constructs an inferencer 40 for estimating the response rate of the user U with respect to the selected intervention pattern based on the attribute information of the user U. A plurality of inferencers 40 are provided for each selected intervention pattern.

FIG. 2 will now be referred to again for description. The optimization device 20 is a device for presenting an incentive to a user to encourage the user to perform a specific behavior. The optimization device 20 includes an acquisition unit 21, an inference unit 22, an optimization unit 23, and inferencers 40. The inferencer 40 is a portion generated by the inferencer generation device 10. The inferencer 40 is, for example, an estimation model trained through machine learning. Each functional unit will be described in detail below.

The acquisition unit 21 acquires a plurality of inferencers 40 from the inferencer generation device 10. The acquisition unit 21 acquires attribute information of an unidentified user group from the inferencer generation device 10. The acquisition unit 21 outputs the acquired attribute information of the user U to the inference unit 22. The acquisition unit 21 may acquire attribute information of a plurality of users U registered in a server managed by a business operator as attribute information of an unidentified user group, or may acquire the attribute information from other devices or servers other than those described above. The unidentified user group is a user group to which an incentive may be presented by the incentive providing device 30 in the future, for example, a user group to which a business operator or the like wishes to present an incentive and intervene.

The acquisition unit 21 acquires the reference incentive amount N from the inferencer generation device 10. The acquisition unit 21 may acquire the reference incentive amount N input from an input interface provided in the optimization device 20, or may store the reference incentive amount N in advance. The acquisition unit 21 outputs the acquired reference incentive amount N to the optimization unit 23. When the reference incentive amount N is updated, the acquisition unit 21 outputs the reference incentive amount N to the optimization unit 23 again.

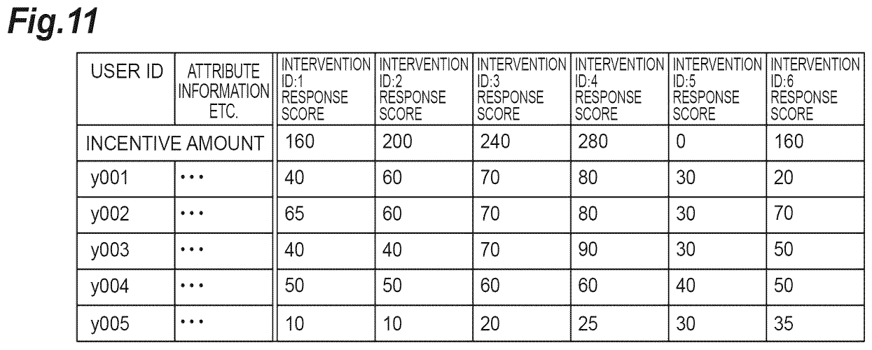

The inference unit 22 uses the inferencer 40 to infer a response score based on the attribute information. Specifically, the inference unit 22 infers, for each selected intervention pattern, a response score indicating the degree of response of a user U based on attribute information of the user U to be inferred, which is a combination of a non-monetary factor and a selected incentive amount. As an example, the inference unit 22 inputs the attribute information of the user U acquired from the acquisition unit 21 to each inferencer 40. The inference unit 22 aggregates the outputs from the plurality of inferencers 40 for each inferencer 40, and calculates the response score of the user U for each selected intervention pattern. FIG. 11 is a diagram illustrating the response rate of each user U for each selected intervention pattern. In the example illustrated in FIG. 11, the inference unit 22 inputs attribute information of a user U corresponding to user ID: y001 to each inferencer 40. The inference unit 22 calculates the response score of the user U with respect to the selected intervention pattern of intervention ID: 1 as 40 based on the output from the inferencer 40 corresponding to intervention ID: 1. Similarly, the inference unit 22 calculates the response scores of the user U for the selective patterns of intervention IDs: 2 to 6 as 60, 70, 80, 30, and 20, respectively. In this way, the inference unit 22 estimates the response score with respect to each selected intervention pattern for one or more users U who wish to intervene.

The optimization unit 23 determines an intervention pattern to be presented to the user U based on the response score inferred by the inference unit 22. Specifically, the optimization unit 23 determines the intervention pattern so that the sum of the response scores of a plurality of the users satisfies a predetermined condition, within a range in which the sum of incentive amounts of a plurality of the users U does not exceed a first threshold. The predetermined condition is, for example, a condition that the sum of the numerical values obtained by dividing the incentive amount by the response score becomes smaller than a reference value. As an example, in a case where the sum of the response scores is F(X) and the sum of the incentive amounts is G(X), F(X) is maximized such that G(X) is less than or equal to a first threshold. The first threshold is a numerical value corresponding to the upper limit value of the incentive amount that the business operator can provide to the user U, and is, for example, a numerical value obtained by multiplying the reference incentive amount N by the number of users U.

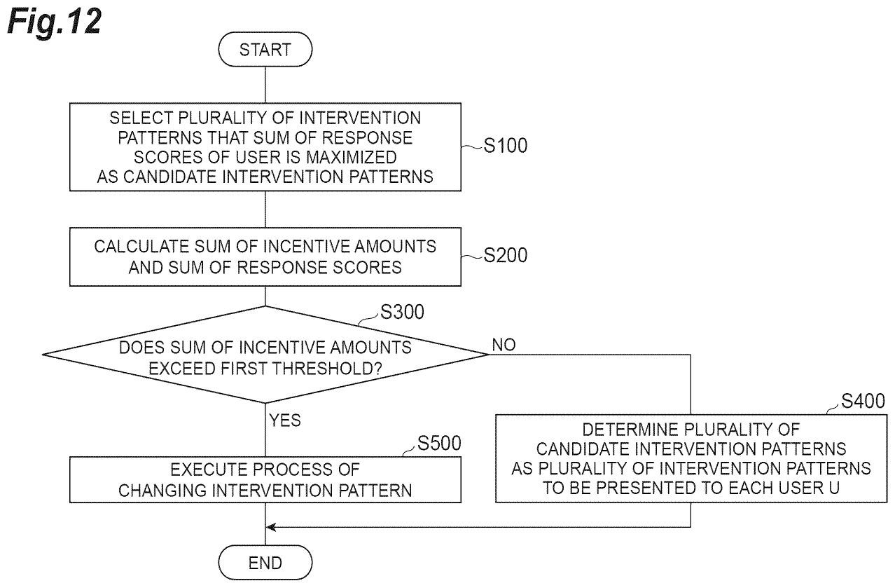

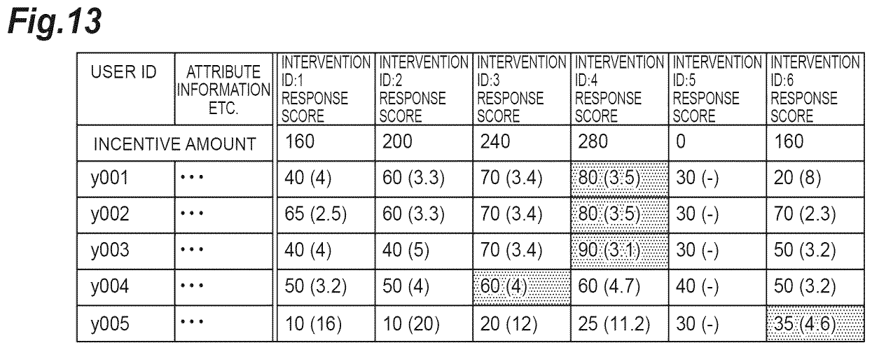

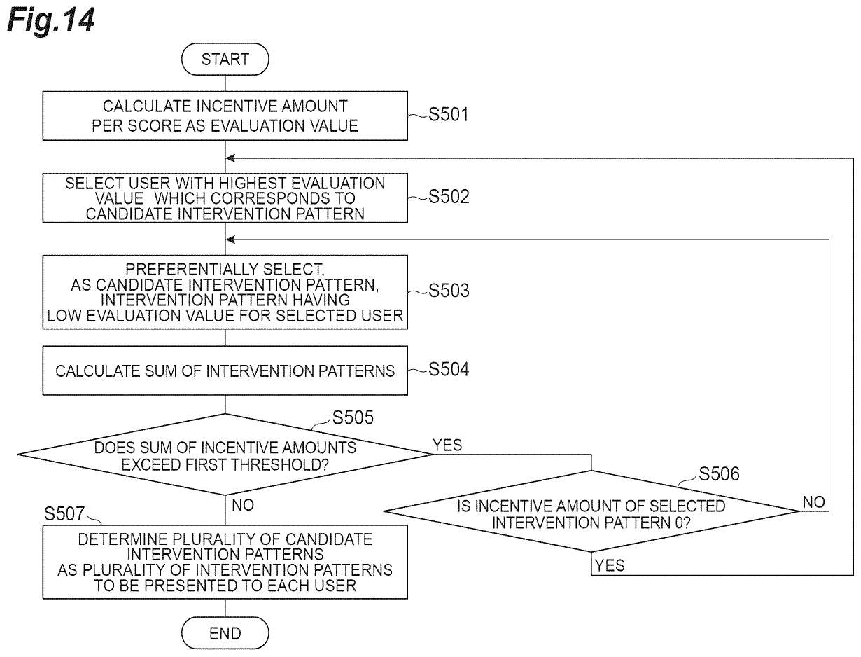

FIG. 12 is a flowchart illustrating a procedure of a process of determining an intervention pattern by the optimization unit 23. FIG. 14 is a flowchart illustrating a procedure of a process of changing the intervention pattern by the optimization unit 23. FIGS. 13, 15, and 16 are diagrams for describing a process of determining an intervention pattern by the optimization unit 23. FIGS. 13, 15, and 16 show the response rate of each user U for each selected intervention pattern, and a numerical value obtained by dividing each response rate by the incentive amount included in the intervention pattern. The optimization unit 23 executes the following optimization process.

As illustrated in FIG. 12, the optimization unit 23 selects, for each user U, a plurality of intervention patterns in which the sum of the response scores of the user U is maximized as candidate intervention patterns (step S100). In the example illustrated in FIG. 13, the optimization unit 23 selects intervention ID: 4, which has a response score of 80, as a candidate intervention pattern for the user U corresponding to user ID: y001. Similarly, the optimization unit 23 selects candidate intervention patterns for a plurality of users U corresponding to user IDs: y002 to y005, respectively, as follows (see the shaded portions in FIG. 13).
User ID: y002→Intervention ID: 4
User ID: y003→Intervention ID: 4
User ID: y004→Intervention ID: 3
User ID: y005→Intervention ID: 6

The optimization unit 23 calculates the sum of the incentive amounts and the sum of the response scores for a plurality of candidate intervention patterns (step S200). The optimization unit 23 determines whether or not the sum of the incentive amounts of the plurality of users U exceeds a first threshold (step S300). In a case where the sum of the incentive amounts of the plurality of users U does not exceed the first threshold (step S300: NO), the optimization unit 23 determines the plurality of candidate intervention patterns as a plurality of intervention patterns to be presented to each user U and ends the optimization process (step S400). In a case where the sum of the incentive amounts of the plurality of users U exceeds the first threshold (step S300: YES), the optimization unit 23 executes a process of changing the intervention pattern (step S500). In the example illustrated in FIG. 13, the optimization unit 23 calculates the sum of the incentive amounts for intervention IDs: 4, 4, 4, 3, and 6 to be 1240 (see FIG. 6). The optimization unit 23 calculates the sum of the response scores to be 345. Here, when the first threshold is 1000, the sum of the incentive amounts, 1240, exceeds the first threshold of 1000. Therefore, the optimization unit 23 executes a process of changing the intervention pattern.

The process of changing the intervention pattern (step S500) will be described in detail below. The optimization unit 23 calculates a numerical value obtained by dividing the incentive amount corresponding to each response score by the response score, and uses the numerical value as an incentive amount per score (hereinafter referred to as an “evaluation value”) (step S501). In the example illustrated in FIG. 13, the optimization unit 23 uses the response score of each user U corresponding to user IDs: y001 to y005 to divide the incentive amount for each intervention ID. For example, the optimization unit 23 divides the incentive amount 160 of intervention ID: 1 by 40, the response score of each user U corresponding to user ID: y001, and calculates an evaluation value of 4. In FIG. 13, “-” means that evaluation is not possible.

The optimization unit 23 selects the user with the highest evaluation value from among the plurality of users U corresponding to the plurality of candidate intervention patterns, respectively (step S502). A higher evaluation value means a larger amount of incentives spent per score. An intervention pattern with a high evaluation value is an intervention pattern that is not profitable for the business operator. A user U with a high evaluation value is unlikely to take a specific behavior even if the amount of incentive presented to the user U is increased. In the example illustrated in FIG. 13, for a user U corresponding to user ID: y005, the evaluation value of the candidate intervention pattern is 4.6. This evaluation value is the highest evaluation value among the evaluation values of the user U with respect to the plurality of candidate intervention patterns. Therefore, the optimization unit 23 selects the user U corresponding to user ID: y005.

The optimization unit 23 preferentially selects, as a candidate intervention pattern, an intervention pattern with a low evaluation value for the selected user (step S503). The optimization unit 23 calculates the sum of the incentive amounts of the candidate intervention patterns (step S504). The optimization unit 23 determines whether or not the sum of the incentive amounts exceeds a first threshold (step S505). In a case where the sum of the incentive amounts exceeds the first threshold (step S505: YES), the optimization unit 23 determines whether or not the incentive amount of the selected intervention pattern is 0 (step S506). In a case where the sum of the incentive amounts does not exceed the first threshold (step S505: NO), the optimization unit 23 determines the plurality of candidate intervention patterns as a plurality of intervention patterns to be presented to each user U and ends the process of changing the intervention pattern (step S507).

In a case where the optimization unit 23 determines that the incentive amount is 0 (step S506: YES), the optimization unit 23 selects the user with the next highest evaluation value from among the plurality of users U corresponding to the plurality of candidate intervention patterns, respectively (step S502). In a case where the optimization unit 23 determines that the incentive amount is not 0 (step S506: NO), the optimization unit 23 selects, for the selected user, the intervention pattern with the next lowest evaluation value as a candidate intervention pattern (step S503).

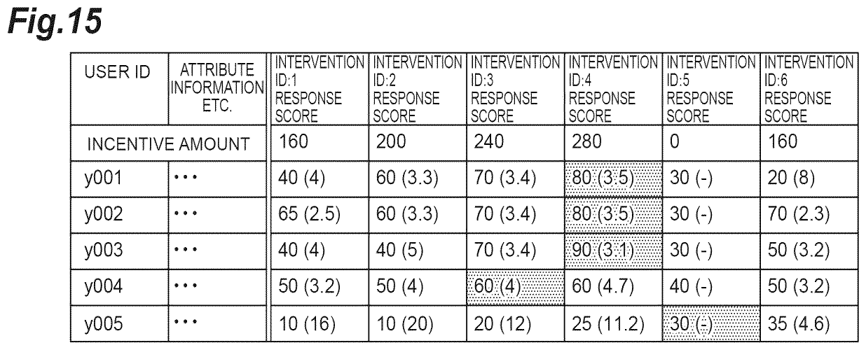

In the example illustrated in FIG. 15, the optimization unit 23 selects intervention ID: 4, which is the intervention pattern with the lowest evaluation value, as a candidate intervention pattern for the user U corresponding to the selected user ID: y005 (steps S502 and S503). Since the sum of the incentive amounts of the plurality of candidate intervention patterns, 1240, exceeds the first threshold of 1000 (step S505: YES) and the incentive amount of the changed intervention pattern is not 0 (step S506: NO), the optimization unit 23 selects intervention ID: 3, which is the intervention pattern with the next lowest evaluation value, as the candidate intervention pattern (step S503). Thereafter, after repeatedly executing steps S503 to S506, the optimization unit 23 selects intervention ID: 5 as a candidate intervention pattern (step S503). Since the sum of the incentive amounts of the plurality of candidate intervention patterns, 1080, exceeds the first threshold of 1000 (step S505: YES) and the incentive amount of the changed intervention pattern is 0 (step S506: YES), the optimization unit 23 selects the user U corresponding to user ID: y004 as the user U with the next highest evaluation value among the evaluation values of the user U with respect to the plurality of candidate intervention patterns (step S502). Through the above process, candidate intervention patterns is selected for each user U as follows.
User ID: y001→Intervention ID: 4
User ID: y002→Intervention ID: 4
User ID: y003→Intervention ID: 4
User ID: y004→Intervention ID: 3
User ID: y005→Intervention ID: 5

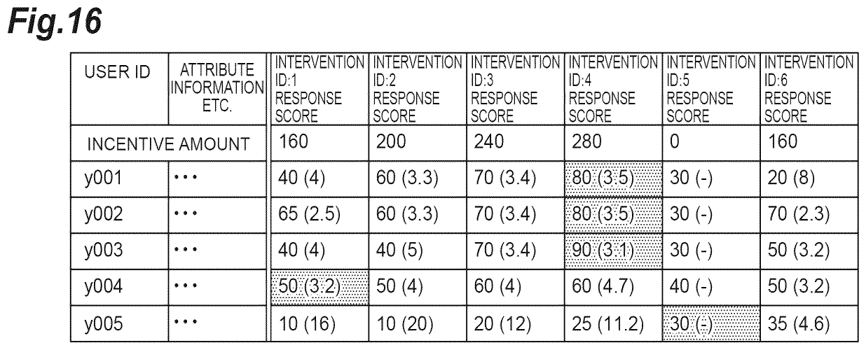

As illustrated in FIG. 16, the optimization unit 23 selects intervention ID: 1, which is the intervention pattern with the lowest evaluation value, as a candidate intervention pattern for the selected user U (step S503). In step S503, the optimization unit 23 may select intervention ID: 6 as a candidate intervention pattern, but intervention ID: 1 is selected as the candidate intervention pattern because it is associated with the same non-monetary factors as the intervention pattern before the change. Since the sum of the incentive amounts of the candidate intervention patterns, 1000, does not exceed the first threshold of 1000 (step S505: NO), the optimization unit 23 determines each candidate intervention pattern as the intervention pattern to be presented to each user U (step S507). At this time, the sum of the response scores per user decreases by 3 compared to when the optimization process started. As described above, the optimization unit 23 can determine an intervention pattern such that the sum of the incentive amounts does not exceed the first threshold while suppressing a decrease in the response score per user.
User ID: y001→Intervention ID: 4
User ID: y002→Intervention ID: 4
User ID: y003→Intervention ID: 4
User ID: y004→Intervention ID: 1
User ID: y005→Intervention ID: 5

The method of the optimization process is not limited to the above. For example, the optimization unit 23 may determine an intervention pattern by providing methods such as the greedy method during the optimization process such that the response score satisfies a predetermined condition, within a range in which the sum of the incentive amounts of a plurality of users U does not exceed a first threshold.

Also, for example, the optimization unit 23 may determine an intervention pattern such that the total number of users U whose response scores exceed a second threshold satisfies a predetermined condition, within a range in which the sum of the incentive amounts of a plurality of users U does not exceed a first threshold. Specifically, in a case where the sum of candidate intervention patterns exceeds a first threshold, the optimization unit 23 executes an optimization process and determines an intervention pattern such that the total number of users U whose response scores exceed a second threshold satisfies a predetermined condition. As an example, in a case where the number of users U whose sum of the response scores exceeds a second threshold is F(X) and the sum of the incentive amounts of the candidate intervention patterns is G(X), F(X) is maximized such that G(X) is equal to or less than a numerical value obtained by multiplying the reference incentive amount N by the number of users U. In the example illustrated in FIG. 13, the optimization unit 23 may determine an intervention ID for each user U in the optimization process such that the total number of users U whose response scores exceed the second threshold of 60 is three or more. As an example, the optimization unit 23 may determine intervention IDs: 2, 2, 3, 3, and 5 for a plurality of users U corresponding to user IDs: y001 to y005, respectively.

As described above, the optimization device 20 measures the response score with respect to each selected intervention pattern for each user U, and determines the intervention pattern to be presented to each user to maximize the response score without causing the sum of all incentive amounts to exceed an upper limit. For example, when actually distributing a selected intervention pattern to a user U, the inference unit 22 estimates the response rate of the user U with respect to each selected intervention pattern based on the attribute information of the user U, to which the distribution is to be made, acquired by the acquisition unit 21. The optimization unit 23 executes the optimization process of the response score, using as the upper limit of the incentive amount a value obtained by multiplying the number of users U to be distributed by the reference incentive amount 200. Therefore, the optimization device 20 maximizes the sum of response rates of all users U, with the constraint that the sum of all incentive amounts falls within the maximum value of the incentive amount that the business operator can provide.

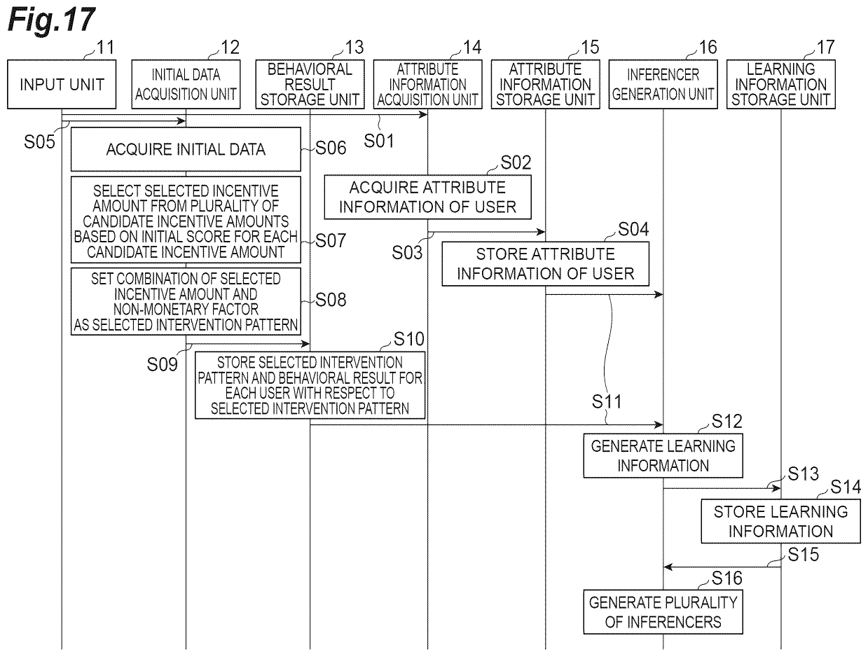

Next, information processing in the information processing system 100 will be described. FIG. 17 is a sequence diagram illustrating a processing procedure of information processing for generating the inferencer 40 in the inferencer generation device 10. The processing procedure of information processing for generating the inferencer 40 will be described below.

First, the input unit 11 receives an input of attribute information of the user U, and outputs the attribute information of the user U to the attribute information acquisition unit 14 (step S01). Then, the attribute information acquisition unit 14 acquires the attribute information of the user U from the input unit 11 (step S02), and outputs the attribute information of the user U to the attribute information storage unit 15 (step S03). Next, the attribute information storage unit 15 stores the attribute information of the user U acquired from the attribute information acquisition unit 14 (step S04).

The input unit 11 receives an input of initial data including initial scores for candidate incentive amounts, and outputs the initial data to the initial data acquisition unit 12 (step S05). The initial data acquisition unit 12 acquires the initial data from the input unit 11 (step S06). The initial data acquisition unit 12 selects a selected incentive amount from the plurality of candidate incentive amounts based on the initial score for each candidate incentive amount (step S07). The initial data acquisition unit 12 sets a combination of the selected incentive amount and the non-monetary factor as a selected intervention pattern (step S08). The initial data acquisition unit 12 outputs the selected intervention pattern to the behavioral result storage unit 13 (step S09). The behavioral result storage unit 13 stores the selected intervention pattern acquired from the initial data acquisition unit 12 and the behavioral result for each user U with respect to the selected intervention pattern (step S10). The behavioral result and the selected intervention patterns are obtained through prior testing.

After steps S01 to S10 are executed, the inferencer generation unit 16 acquires attribute information of a user U from the attribute information storage unit 15, and acquires the selected intervention pattern and the behavioral results of the user U with respect to the selected intervention pattern from the behavioral result storage unit 13 (step S11). The inferencer generation unit 16 generates learning information by associating the selected intervention pattern and the behavioral result with attribute information of a plurality of users U based on information identifying the user U (step S12). The inferencer generation unit 16 outputs the learning information to the learning information storage unit 17 (step S13), and the learning information storage unit 17 stores the learning information (step S14). The inferencer generation unit 16 acquires the learning information from the learning information storage unit 17 (step S15). Finally, the inferencer generation unit 16 generates a plurality of inferencers 40 for each selected intervention pattern through machine learning using the attribute information and the behavioral results included in the learning information (step S16). After generating the learning information (step S12), the inferencer generation unit 16 may generate a plurality of inferencers 40 as it is (step S16).

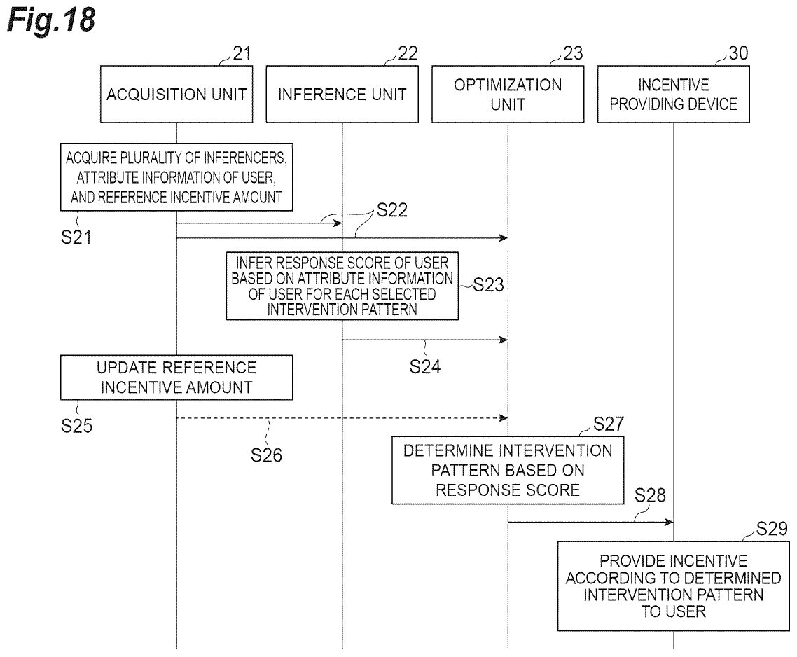

FIG. 18 is a sequence diagram illustrating processing procedures of information processing for determining an intervention pattern in the optimization device 20 and information processing for providing an incentive by the incentive providing device 30. First, the acquisition unit 21 acquires a plurality of inferencers 40, attribute information of the user U, and a reference incentive amount N from the inferencer generation device 10 (step S21). Next, the acquisition unit 21 outputs the attribute information of the user U to the inference unit 22, and outputs the reference incentive amount N to the optimization unit 23 (step S22). Next, the inference unit 22 infers a response score indicating the degree of response of the user U based on the attribute information of the user U for each selected intervention pattern using the inferencer 40 (step S23). Next, the inference unit 22 outputs the response score for each selected intervention pattern to the optimization unit 23 (step S24).

Next, in a case where the reference incentive amount N is updated, the acquisition unit 21 acquires the reference incentive amount N again (step S25). The acquisition unit 21 outputs the updated reference incentive amount N to the optimization unit 23 (step S26). The optimization unit 23 determines an intervention pattern to be presented to the user U based on the response score inferred by the inference unit 22 (step S27). The optimization unit 23 outputs the determined intervention pattern to the incentive providing device 30 (step S28). Finally, the incentive providing device 30 presents the intervention pattern determined by the optimization device 20 to the user U (step S29).

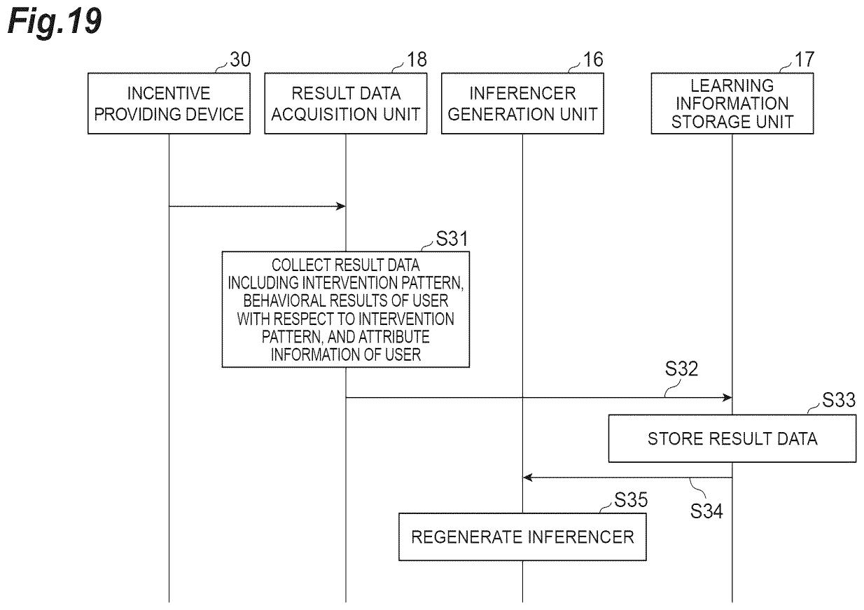

FIG. 19 is a sequence diagram illustrating a processing procedure of information processing for regenerating the inferencer 40 in the inferencer generation device 10. The processing procedure of information processing for regenerating the inferencer 40 will be described below. First, the intervention pattern determined in advance by the optimization device 20 is presented to each user U by the incentive providing device 30. Next, the result data acquisition unit 18 collects result data from the incentive providing device 30, the result data including the intervention pattern presented to each user U by the incentive providing device 30, the behavioral results of the user U with respect to the intervention pattern, and attribute information of the user U (step S31). The result data acquisition unit 18 outputs the acquired result data to the learning information storage unit 17 (step S32), and the behavioral result storage unit 13 stores the result data (step S33). Next, the inferencer generation unit 16 acquires the result data from the behavioral result storage unit 13 (step S34). Finally, the inferencer generation unit 16 regenerates the inferencer 40 corresponding to the intervention pattern included in the result data, using the attribute information and the behavioral results included in the result data (step S35). As described above, the inferencer 40 is updated using data resulting from application of the intervention pattern determined by the optimization device 20 to each user U (intervention pattern distribution results).

Next, the effects of the inferencer generation device 10 and the optimization device 20 according to the present disclosure will be described.

The optimization device 20 according to the present disclosure is a device for presenting an incentive to a user U to change the behavior of the user U. This optimization device 20 includes an inference unit 22 that infers, for each intervention pattern, a response score indicating the degree of response of a user U based on attribute information of the user U to be inferred, each intervention pattern being a combination of a non-monetary factor that is a means for encouraging the user U to perform a specific behavior and an incentive amount that is a monetary reward for the specific behavior, and an optimization unit 23 that determines the intervention pattern based on the response score. According to this configuration, the response score of the user U is inferred for each intervention pattern based on the attribute information of the user U, and the intervention pattern to be presented to the user is determined based on the response score for each intervention pattern. Accordingly, it is possible to determine an intervention pattern to be presented to the user U so as to increase the probability that the behavior of the user U will change. For example, the incentive amount included in the intervention pattern presented to the user U can be set individually, thereby increasing the probability that the user U will undergo behavioral change.

The above effects will be described. First, as a premise, in a case where a non-monetary factor is combined with an incentive amount and presented to the user U, simply combining them does not necessarily improve the probability that the user U will undergo behavioral change. This is because psychological changes differ for each user U when the same intervention pattern is presented. As an example, in a case where a user who is already motivated to change their behavior is given extrinsic motivation, such as by presenting an incentive, in order to change the behavior of the user, in some cases, the motivation decreases and the behavior of the user does not change, but in other cases, the user's intrinsic motivation increases, and the behavior of the user changes. In this way, when a user's purpose for performing a specific behavior changes, the motivation for performing the specific behavior changes for each user.

As another example, when a user is motivated to change their behavior by being presented with an incentive amount, being presented with an intervention pattern that includes non-monetary factors such as social normative factors may reduce the motivation and cause the behavior of the user to not change. The social normative factor is, for example, presenting information to the user that performing a specific behavior will contribute to environmental conservation or society. In this way, if a user feels that he or she is being externally forced to perform a specific behavior, his or her motivation to perform the specific behavior may decrease.

From the above, in a case where an incentive amount, which is a monetary reward, is combined with a non-monetary factor, the response of users to the combination will vary from user to user. Specifically, when the same combination is presented to a plurality of users, whether or not the behavior of each user changes varies from user to user. Therefore, when a combination of an incentive amount and a non-monetary factor is provided to a user, the probability of changing the behavior of the user is not necessarily high. In contrast, the optimization device 20 according to the present disclosure optimizes the incentive amount presented to the user U while taking into account the influence of non-monetary factors. This can improve the behavioral change rate of the user U. For example, it is possible to determine an intervention pattern using logic based on the psychology of each user U.

The optimization unit 23 determines an intervention pattern such that the sum of the response scores of a plurality of satisfies a predetermined condition, within a range in which the sum of incentive amounts of the plurality of the users U does not exceed a first threshold. With this configuration, it is possible to determine an intervention pattern to be presented to the user U so that the probability that the behavior of the user U will change becomes higher within the range of the incentive amount that the business operator can grant to the user U. Furthermore, in the service that the business operator provides to the user U, the incentive amount that the business operator can distribute to the user U is limited. Therefore, the above configuration makes it possible to increase the behavioral change rate of the user U with a limited incentive amount.

The optimization unit 23 determines an intervention pattern such that the sum of the numerical values obtained by dividing the incentive amount by the response score becomes smaller. With this configuration, it is possible to determine an intervention pattern such that the probability that the behavior of the user U will change in response to the incentive amount presented to the user is increased.

The inference unit 22 infers a response score based on the attribute information using an inferencer 40, and the inferencer 40 is generated by machine learning using the attribute information and the behavioral results of each user U with respect to the intervention pattern. With this configuration, it is possible to infer the response score for each intervention pattern with greater accuracy.

The plurality of inferencers 40 are generated by machine learning for each intervention pattern. With this configuration, it is not necessary to input explanatory variables corresponding to the intervention pattern to the inferencer 40, and thus the inferencer 40 can be generated more easily. Moreover, by preparing the inferencer 40 according to the intervention pattern, the inference accuracy can be improved.

The inference unit 22 infers a response score for each selected intervention pattern, which is a combination of a selected incentive amount and a non-monetary factor, and the selected incentive amount is selected from a plurality of candidate incentive amounts, which are a plurality of incentive amounts determined at predetermined intervals based on a reference incentive amount, based on an initial score, which is the response score for each of the candidate incentive amounts. With this configuration, it is possible to determine a combination of an appropriate incentive amount and a non-monetary factor as a selected intervention pattern. As a result, the process of determining an intervention pattern to be presented to the user U so as to make higher the probability that the behavior of the user U will change can be more easily realized.

The above-mentioned effects will now be described in detail. Since the utility of the incentive amount in the intervention pattern presented to the user U is great, care must be taken in the amount of incentives to be combined. For example, in a case where a user is presented with an intervention pattern that combines a non-monetary factor with an extremely large incentive amount, the behavior of the user will change with a high probability. However, it becomes difficult to specify (interpret) which of the three reasons caused the change in the behavior of the user: the presentation of an extremely large incentive amount, the fact that non-monetary factors were attractive to the user U, and the fact that the combination of the incentive amount and the non-monetary factors was attractive to the user U. Furthermore, for example, in a case where a non-monetary factor is combined with an extremely small incentive amount, the effect of changing the behavior of the user will be small, and the fact that “an extremely small incentive amount is presented” is likely to have a negative effect on the motivation of the behavioral change of the user. Therefore, there is a likelihood that the effect may be reduced.

For the above reasons, the inventors of the present invention have considered that it is not necessary to present, to the user, an intervention pattern that is a combination of an extremely large incentive amount or an extremely small incentive amount and a non-monetary factor. Therefore, in the optimization device 20 according to the present disclosure, it is possible to determine, as a selected intervention pattern, a combination of an appropriate incentive amount other than an extremely large incentive amount or an extremely small incentive amount, and a non-monetary factor. Accordingly, an incentive amount that is large enough to contribute to a change in behavior of the user U when combined with a non-monetary factor is selected as the selected incentive amount, and a response score is inferred only for an intervention pattern that is a combination of the selected incentive amount and a non-monetary factor. As a result, the process of determining an intervention pattern to be presented to the user U to increase the probability that the behavior of the user U will change can be more easily realized.

A selected incentive amount is selected from a plurality of candidate incentive amounts based on a statistical value of the calculated initial scores. With this configuration, the process of setting an appropriate incentive amount as the selected incentive amount can be more easily realized.

The non-monetary factor is at least one of nudge and gamification. According to this configuration, when an intervention pattern that is a combination of a non-monetary factor and an incentive amount is presented to the user U, it is possible to more effectively change the behavior of the user U. The non-monetary factor is not limited to the above, but may be any means for changing the behavior of the user without granting a monetary reward.

The attribute information of the user U includes at least information indicating the gender of the user U and information indicating the age of the user U. With this configuration, the attribute information of user U includes information that is likely to reflect the user U's values regarding the behavior of the user U. This enables the inference unit 22 to improve the accuracy of estimating the response score of the user U.

The inferencer generation device 10 according to the present disclosure includes a learning information storage unit 17 that stores an intervention pattern, which is a combination of a non-monetary factor that is a means for encouraging a user U to perform a specific behavior and an incentive amount that is a monetary reward for the specific behavior, and a behavioral result for each user U with respect to the intervention pattern, an attribute information acquisition unit 14 that acquires attribute information of a plurality of users U, and an inferencer generation unit 16 that generates a plurality of inferencers 40 for each intervention pattern by machine learning using the attribute information and the behavioral results. According to this configuration, it is possible to generate an inferencer 40 that accurately infers the behavioral results of the user U for each intervention pattern based on attribute information of the user U.

The optimization unit 23 may determine an intervention pattern such that the total number of users U whose response scores exceed a second threshold satisfies a predetermined condition, within a range in which the sum of the incentive amounts of a plurality of users U does not exceed a first threshold. With this configuration, in a case where an intervention pattern is presented to each user U, the number of users U whose behavior changes at a probability exceeding the second threshold becomes the predetermined condition. Accordingly, it is possible to suppress a decrease in the number of users U whose behavior changes.

In the above embodiment, the inferencer generation device 10 generated a plurality of inferencers 40, but the present invention is not limited thereto. The inferencer generation device 10 may generate one inferencer 40. In this case, the inferencer generation unit 16 may use attribute information and an intervention ID of the user U as explanatory variables and the behavioral results of the user U as objective variables to generate the inferencer 40 through machine learning. The inference unit 22 of the optimization device 20 may use the inferencer 40 to infer the response score of the user U based on the attribute information of the user U and the intervention ID.

In the above embodiment, the information processing system 100 only needs to be able to determine the intervention pattern to be presented to the user U. For example, the inferencer generation device 10 may not be included. In this case, a table showing the correspondence relationship between the attribute information of the user U and the response score of the user U may be set by the optimization device 20 or the business operator. The inference unit 22 of the optimization device 20 may output a response score corresponding to the attribute information of the user U as an inference result based on the above table.

The optimization device and the inferencer generation device according to the present disclosure have the following configuration.

[1] An optimization device for presenting an incentive to a user to change a behavior of the user, the optimization device including:
an inference unit configured to infer, for each intervention pattern, a response score indicating a degree of response of a user based on attribute information of the user to be inferred, each intervention pattern being a combination of a non-monetary factor that is a means for encouraging the user to perform a specific behavior and an incentive amount that is a monetary reward for the specific behavior; and
an optimization unit configured to determine the intervention pattern based on the response score.

[2] The optimization device according to [1], in which the optimization unit determines the intervention pattern such that a sum of the response scores satisfies a predetermined condition, within a range in which a sum of incentive amounts of a plurality of the users does not exceed a first threshold.

[3] The optimization device according to [2], in which the optimization unit determines the intervention pattern such that a sum of numerical values obtained by dividing the incentive amount by the response score becomes smaller.

[4] The optimization device according to [1], in which the optimization unit determines the intervention pattern such that a total number of users whose response scores exceed a second threshold satisfies a predetermined condition, within a range in which a sum of incentive amounts of a plurality of the users does not exceed a first threshold.

[5] The optimization device according to any one of [1] to[4], in which
the inference unit infers the response score based on the attribute information using an inferencer, and
the inferencer is generated by machine learning using the attribute information and behavioral results for each user with respect to the intervention pattern.

[6] The optimization device according to [5], in which
a plurality of the inferencers are prepared for each intervention pattern, and
   the plurality of inferencers are generated by machine learning for each intervention pattern.

[7] The optimization device according to any one of [1] to[6], in which
the inference unit infers the response score for each selected intervention pattern, which is a combination of a selected incentive amount and the non-monetary factor, and
   the selected incentive amount is selected from a plurality of candidate incentive amounts based on an initial score, which is the response score for each of the candidate incentive amounts, the candidate incentive amounts being a plurality of the incentive amounts determined at predetermined intervals based on a reference incentive amount.

[8] The optimization device according to [7], in which the selected incentive amount is selected from the plurality of candidate incentive amounts based on a calculated statistical value of the initial score.

[9] The optimization device according to any one of [1] to[8], in which the non-monetary factor is at least one of nudge and gamification.

[10] An inferencer generation device including:
a learning information storage unit configured to store an intervention pattern, which is a combination of a non-monetary factor that is a means for encouraging a user to perform a specific behavior and an incentive amount that is a monetary reward for the specific behavior, and a behavioral result for each user with respect to the intervention pattern;
   an attribute information acquisition unit configured to acquire attribute information of a plurality of the users; and
   an inferencer generation unit configured to generate a plurality of inferencers for each intervention pattern by machine learning using the attribute information and the behavioral results.

In the block diagrams used in the description of the above embodiment, blocks of functional units are illustrated. These functional blocks (components) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. The functional blocks may be realized by one device or a plurality of devices described above and software in combination.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (component) that enables transmission is referred to as a transmitting unit or a transmitter. In either case, as described above, realization methods are not particularly limited.

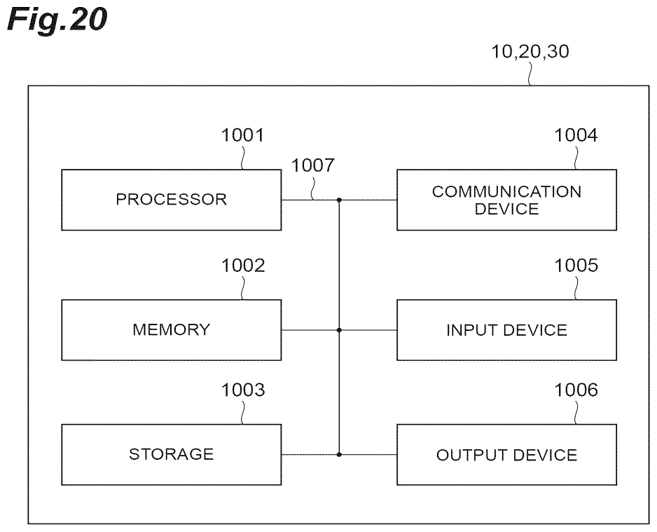

For example, the inferencer generation device 10, the optimization device 20, and the incentive providing device 30 according to an embodiment of the present disclosure may each function as a computer that determines the intervention pattern of the present disclosure. FIG. 20 is a diagram illustrating an example of a hardware configuration of the inferencer generation device 10, the optimization device 20, and the incentive providing device 30 according to an embodiment of the present disclosure. The above-mentioned inferencer generation device 10, optimization device 20, and incentive providing device 30 may be physically configured as computer devices including a processor 1001, a memory 1002, a storage 1003, a communication device 1004, an input device 1005, an output device 1006, a bus 1007, and the like.

In the following description, the term “device” can be interpreted as a circuit, a device, a unit, or the like. The hardware configurations of the inferencer generation device 10, the optimization device 20, and the incentive providing device 30 may be configured to include one or more of the devices shown in the drawings, or may be configured to exclude some of the devices.

Each function in the inferencer generation device 10, the optimization device 20, and the incentive providing device 30 is realized by loading predetermined software (a program) into hardware such as the processor 1001 or the memory 1002 such that the processor 1001 performs calculation to control communication that is performed by the communication device 1004 or control at least one of reading and writing of data in the memory 1002 and the storage 1003.

The processor 1001, for example, controls the entire computer by operating an operating system. The processor 1001 may be configured as a central processing unit (CPU) including an interface with peripheral devices, a controller, an arithmetic operation unit, and a register. For example, the above-described inferencer generation unit 16 and the like may be realized by the processor 1001.

The processor 1001 reads a program (a program code), a software module, data, or the like from at least one of the storage 1003 and the communication device 1004 to the memory 1002 and executes various processes in accordance therewith. As the program, a program that causes a computer to execute at least some of the operations described above in the embodiment is used. For example, the input unit 11, the initial data acquisition unit 12, the attribute information acquisition unit 14, the inferencer generation unit 16, the result data acquisition unit 18, the acquisition unit 21, the inference unit 22, and the optimization unit 23 may be realized by a control program stored in the memory 1002 and operating in the processor 1001 and may be realized similarly for other functional blocks. The various processes described above are described as being executed by a single processor 1001, but they may be simultaneously or sequentially executed by two or more processors 1001. The processor 1001 may be mounted as one or more chips. The program may be transmitted from a network via a telecommunication line.

The memory 1002 is a computer-readable recording medium and may be constituted by, for example, at least one of a read-only memory (ROM), an erasable programmable ROM (EPROM), an electrically erasable programmable ROM (EEPROM), and a random-access memory (RAM). The memory 1002 may be referred to as a register, a cache, a main memory (main storage device), or the like. The memory 1002 can store a program (a program code), a software module, and the like that can be executed to implement the accompanying discrimination method according to one embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage medium described above, for example, may be a database including at least one of the memory 1002 and the storage 1003, a server, or any other appropriate medium.

The communication device 1004 is hardware (a transmission/reception device) that performs communication between computers via at least one of a wired network and a wireless network and is also referred to as, for example, a network device, a network controller, a network card, or a communication module. The communication device 1004 may be configured to include a high frequency switch, a duplexer, a filter, a frequency synthesizer, and the like, for example, in order to realize at least one of frequency division duplex (FDD) and time division duplex (TDD). For example, the acquisition unit 21 and the like may be realized using the communication device 1004. This communication device 1004 may be mounted with being physically or logically divided into a transmission unit and a reception unit.

The input device 1005 is an input device (for example, a keyboard, a mouse, a microphone, a switch, buttons, a sensor, or the like) that receives an input from the outside. The output device 1006 is an output device (for example, a display, a speaker, an LED lamp, or the like) that performs output to the outside. In addition, the input device 1005 and the output device 1006 may have an integrated configuration (for example, a touch panel).

The devices such as the processor 1001 and the memory 1002 are connected to each other via the bus 1007 for communicating information. The bus 1007 may be configured using a single bus, or may be configured using different buses between devices.

Further, the inferencer generation device 10, the optimization device 20, and the incentive providing device 30 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be mounted using at least one of these types of hardware.

Notification of information is not limited to an aspect/embodiment described in the present disclosure and may be performed using a difference method. For example, the notification of information may be performed using physical layer signaling (for example, downlink control information (DCI), uplink control information (UCI)), upper layer signaling (for example, radio resource control (RRC) signaling, medium access control (MAC) signaling, a master information block (MIB), a system information block (SIB)), any other signal, or a combination thereof. In addition, the RRC signaling may be referred to as a RRC message and, for example, may be an RRC connection setup message, an RRC connection reconfiguration message, or the like.

The order of processes, the sequences, the flowcharts, and the like of the aspects/embodiments described above in the present disclosure may be changed unless conflictions arise. For example, in the methods described in the present disclosure, various steps are presented as elements of an exemplary order, but the methods are not limited to the particular order presented.

Information or the like which is input or output may be stored in a specific place (for example, a memory) or may be managed using a management table. The input/output information and the like may be overwritten, updated, or added to. The output information and the like may be deleted. The input information and the like may be transmitted to another device.

A determination may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be used alone, may be used in combination, or may be switched during implementation thereof. In addition, notification of predetermined information (for example, notification of being X) is not limited to be performed explicitly and may be performed implicitly (for example, notification of the predetermined information is not performed).

As above, while the present disclosure has been described in detail, it is apparent to a person skilled in the art that the present disclosure is not limited to the embodiments described in the present disclosure. The present disclosure can be implemented in modified and changed forms without departing from the spirit and scope of the present disclosure, as defined by the claims. Thus, the description of the present disclosure is for the purpose of exemplary description and does not have any limited meaning for the present disclosure.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology is included in the definition of a transmission medium.

Information, a signal, and the like described in the present disclosure may be represented using any one among other various technologies. For example, data, instructions, commands, information, signals, bits, symbols, chips, and the like that may be referred to throughout the above description may be represented by voltages, currents, electromagnetic waves, magnetic fields or magnetic particles, optical fields or photons, or any combination thereof.

In addition, a term described in the present disclosure and a term that is necessary for understanding the present disclosure may be substituted with terms having the same meaning or a meaning similar thereto. For example, at least one of a channel and a symbol may be a signal (signaling). For example, a signal may be a message. In addition, a component carrier (CC) may be referred to as a carrier frequency, a cell, a frequency carrier, or the like.

In addition, information, parameters, and the like described in the present disclosure may be expressed using absolute values, may be expressed using values relative to a predetermined value, or may be expressed using other corresponding information. For example, radio resources may be indicated using indices.

A name used for each parameter described above is not limited in any aspect. In addition, numerical equations using such parameters may be different from those that are explicitly disclosed in the present disclosure. The various channels (for example, a PUCCH, a PDCCH, and the like) and information elements can be identified using all the preferred names, and the various names assigned to such various channels and information elements are not limited in any aspect.

In the present disclosure, terms such as “mobile station (MS),” “user terminal,” “user equipment (UE),” and “terminal” may be used interchangeably.

A mobile station may also be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

Terms such as “determining” used in the present disclosure may include a wide variety of operations. The “determining,” for example, may include a case in which judging, calculating, computing, processing, deriving, investigating, looking up, search, and inquiry (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining.” In other words, “determining” may include a case in which a certain operation is regarded as “determining.” In addition, “determining” may be rephrased with “assuming,” “expecting,” “considering,” and the like.

The terms “connected,” “coupled,” or any variation thereof, refer to direct or indirect connection or coupling between two or more elements and may include the presence of one or more intermediate elements between two elements “connected” or “coupled” to each other. The coupling or connecting between elements may be physical, may be logical, or may be a combination thereof. For example, “connection” may be rephrased as “access.” When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

The expression “based on” used in the present disclosure does not mean “based only on” unless otherwise described. In other words, description of “on the basis of” means both “only on the basis of” and “at least on the basis of.”

Any referring to elements, for which names of “first,” “second,” and the like are used, used in the present disclosure does not generally limit the amount or the sequence of such elements. The terms can be conveniently used to distinguish two or more elements in the present disclosure. Accordingly, referring to the first and second elements does not mean that only the two elements are employed, or the first element needs to precede the second element in a certain form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other.” The term may also mean that “A and B are each different from C.” Terms such as “separated” and “coupled” may also be interpreted in the same way as “different.”

### REFERENCE SIGNS LIST

10 Inferencer generation device, 14 Attribute information acquisition unit, 16 Inferencer generation unit, 17 Learning information storage unit, 20 Optimization device, 22 Inference unit, 23 Optimization unit, 40 Inferencer, U User, N Reference incentive amount, NMF-1, NMF-2 Non-monetary factor, 1001 Processor, 1002 Memory, 1003 Storage, 1004 Communication device, 1005 Input device, 1006 Output device, 1007 Bus

1. An optimization device for presenting an incentive to a user to change a behavior of the user, the optimization device comprising:
an inference unit configured to infer, for each intervention pattern, a response score indicating a degree of response of a user based on attribute information of the user to be inferred, each intervention pattern being a combination of a non-monetary factor that is a means for encouraging the user to perform a specific behavior and an incentive amount that is a monetary reward for the specific behavior; and
an optimization unit configured to determine the intervention pattern based on the response score.

2. The optimization device according to claim 1, wherein the optimization unit determines the intervention pattern such that a sum of the response scores satisfies a predetermined condition, within a range in which a sum of incentive amounts of a plurality of the users does not exceed a first threshold.

3. The optimization device according to claim 2, wherein the optimization unit determines the intervention pattern such that a sum of numerical values obtained by dividing the incentive amount by the response score becomes smaller.

4. The optimization device according to claim 1, wherein the optimization unit determines the intervention pattern such that a total number of users whose response scores exceed a second threshold satisfies a predetermined condition, within a range in which a sum of incentive amounts of a plurality of the users does not exceed a first threshold.

5. The optimization device according to claim 1, wherein the inference unit infers the response score based on the attribute information using an inferencer, and
the inferencer is generated by machine learning using the attribute information and behavioral results for each user with respect to the intervention pattern.

6. The optimization device according to claim 5, wherein a plurality of the inferencers are prepared for each intervention pattern, and
the plurality of inferencers are generated by machine learning for each intervention pattern.

7. The optimization device according to claim 1, wherein the inference unit infers the response score for each selected intervention pattern, which is a combination of a selected incentive amount and the non-monetary factor, and
the selected incentive amount is selected from a plurality of candidate incentive amounts based on an initial score, which is the response score for each of the candidate incentive amounts, the candidate incentive amounts being a plurality of the incentive amounts determined at predetermined intervals based on a reference incentive amount.

8. The optimization device according to claim 7, wherein the selected incentive amount is selected from the plurality of candidate incentive amounts based on a calculated statistical value of the initial score.

9. The optimization device according to claim 1, wherein the non-monetary factor is at least one of nudge and gamification.

10. An inferencer generation device comprising:
a learning information storage unit configured to store an intervention pattern, which is a combination of a non-monetary factor that is a means for encouraging a user to perform a specific behavior and an incentive amount that is a monetary reward for the specific behavior, and a behavioral result for each user with respect to the intervention pattern;
an attribute information acquisition unit configured to acquire attribute information of a plurality of the users; and
an inferencer generation unit configured to generate a plurality of inferencers for each intervention pattern by machine learning using the attribute information and the behavioral results.
